(19) United States
(12) Patent Application Publication
(10) Pub. No.: US 2026/0309902 A1
(43) Pub. Date: Oct. 8, 2026

(54) MODULATING RETROREFLECTOR SUPPORTING MULTI-CHANNEL COMMUNICATION AND METHOD

(71) Applicant: Raytheon Company, Arlington, VA (US)

(72) Inventor: Andrew Kowalevicz, Ashburn, VA (US)

(73) Assignee: Raytheon Company, Arlington, VA (US)

(21) Appl. No.: 19/098,625

(22) Filed: Apr. 2, 2025

(51) Int. Cl. G02B 5/124; G02B 27/14

(52) U.S. Cl. CPC G02B 5/124; G02B 27/142

(57) ABSTRACT

An apparatus includes a modulating retroreflector that includes a plurality of reflective surfaces. Each of the reflective surfaces includes an optical coating and a modulating layer. Each of the optical coatings is configured to transmit a specified wavelength of light different from one or more remaining optical coatings and to reflect specific wavelengths of light transmitted by the one or more remaining optical coatings. The reflective surfaces are configured to receive an optical signal and to provide a reflected optical signal. For each of the reflective surfaces, the modulating layer is configured to modulate the specified wavelength of light in the optical signal transmitted by the optical coating and encode data onto the optical signal at the specified wavelength such that the reflected optical signal represents a multi-channel modulated version of the optical signal.

### TECHNICAL FIELD

This disclosure is generally directed to optical systems. More specifically, this disclosure is directed to a modulating retroreflector supporting multi-channel communication and method.

### BACKGROUND

Free-space optical systems generally include optical nodes that communicate or that otherwise transmit/receive light through free space rather than through fiber optic cables or other physical cables. In some free-space optical systems or other systems, a first optical node can be used to transmit optical signals towards a second optical node, where the second optical node includes a retroreflector. The retroreflector in the second optical node reflects the optical signals back towards the first optical node, which can receive and process the reflected optical signals.

### SUMMARY

This disclosure relates to a modulating retroreflector supporting multi-channel communication and method.

In a first embodiment, an apparatus may include a modulating retroreflector that includes a plurality of reflective surfaces. Each of the reflective surfaces may include an optical coating and a modulating layer. Each of the optical coatings may be configured to transmit a specified wavelength of light different from one or more remaining optical coatings and to reflect specific wavelengths of light transmitted by the one or more remaining optical coatings. The reflective surfaces may be configured to receive an optical signal and to provide a reflected optical signal. For each of the reflective surfaces, the modulating layer may be configured to modulate the specified wavelength of light in the optical signal transmitted by the optical coating and encode data onto the optical signal at the specified wavelength such that the reflected optical signal represents a multi-channel modulated version of the optical signal.

In a second embodiment, a system may include a modulating retroreflector and a control circuit. The modulating retroreflector may include a plurality of reflective surfaces. Each of the reflective surfaces may include an optical coating and a modulating layer. Each of the optical coatings may be configured to transmit a specified wavelength of light different from one or more remaining optical coatings and to reflect specific wavelengths of light transmitted by the one or more remaining optical coatings. The reflective surfaces may be configured to receive an optical signal and to provide a reflected optical signal. For each of the reflective surfaces, the modulating layer may be configured to modulate the specified wavelength of light in the optical signal transmitted by the optical coating and encode data onto the optical signal at the specified wavelength such that the reflected optical signal represents a multi-channel modulated version of the optical signal. The control circuit may be configured to generate a plurality of control signals and to provide one of the plurality of control signals to each of the modulating layers to control the encoding of the data onto the optical signal at each of the modulating layers.

In a third embodiment, a method may include receiving an optical signal at a modulating retroreflector. The modulating retroreflector may include a plurality of reflective surfaces configured to receive the optical signal and to provide a reflected optical signal. Each of the reflective surfaces may include a modulating layer and a corresponding optical coating. The method may also include, at each of the optical coatings, transmitting a specified wavelength of light different from one or more remaining optical coatings and reflecting specific wavelengths of light transmitted by the one or more remaining optical coatings. The method may further include, at each of the modulating layers, modulating the specified wavelength of light in the optical signal transmitted by the corresponding optical coating and encoding data onto the optical signal at the specified wavelength such that the reflected optical signal represents a multi-channel modulated version of the optical signal.

Any single one or any combination of the following features may be used with the first, second, or third embodiment. Each of the optical coatings may include a dielectric coating of silicon dioxide/titanium dioxide that is configured to transmit a different wavelength of light from the one or more remaining optical coatings. Each of the reflective surfaces may further include a base reflector. For each of the reflective surfaces, the modulating layer may be positioned between the optical coating and the base reflector. Each of the modulating layers may be configured to provide phase modulations to the optical signal to encode the data onto the optical signal. Each of the modulating layers may be configured to provide intensity modulations to the optical signal to encode the data onto the optical signal. Each of the modulating layers may include an oriented phase-shifting material. Each of the modulating layers may include at least one of a ferroelectric ceramic and a dielectric ceramic. Each of the modulating layers may include at least one of lead lanthanum zirconate titanate (PLZT), lithium niobate, and barium titanium (BaTi). The modulating retroreflector may include a solid corner-cube modulating retroreflector. A quarter-wave plate may be configured to receive circularly polarized light and to transmit linearly polarized light based on the circularly polarized light. A polarizer may be positioned between the quarter-wave plate and the modulating retroreflector. The polarizer may be configured to transmit the linearly polarized light with a specified orientation to the modulating retroreflector. The modulating retroreflector may be configured to reflect the linearly polarized light received from the polarizer having an orientation rotated by 90 degrees with respect to the specified orientation when no voltage is applied to the modulating retroreflector and to reflect the linearly polarized light received from the polarizer having the specified orientation when a specified voltage is applied to the modulating retroreflector. A plurality of control signals may be generated, and one of the plurality of control signals may be provided to each of the modulating layers to control the encoding of the data onto the optical signal at the modulating layer.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example of an optical system including a modulating retroreflector supporting multi-channel communication according to this disclosure;

FIGS. 2A and 2B illustrate examples of modulating retroreflectors supporting multi-channel communication according to this disclosure;

FIGS. 3A through 3C illustrate examples of reflective surfaces of a modulating retroreflector supporting multi-channel communication according to this disclosure;

FIGS. 4A and 4B illustrate examples of a structure for use in providing intensity modulation encoding with the modulating retroreflector of FIG. 2B according to this disclosure; and

FIG. 5 illustrates an example of a method for providing multi-channel communication with a modulating retroreflector according to this disclosure.

### DETAILED DESCRIPTION

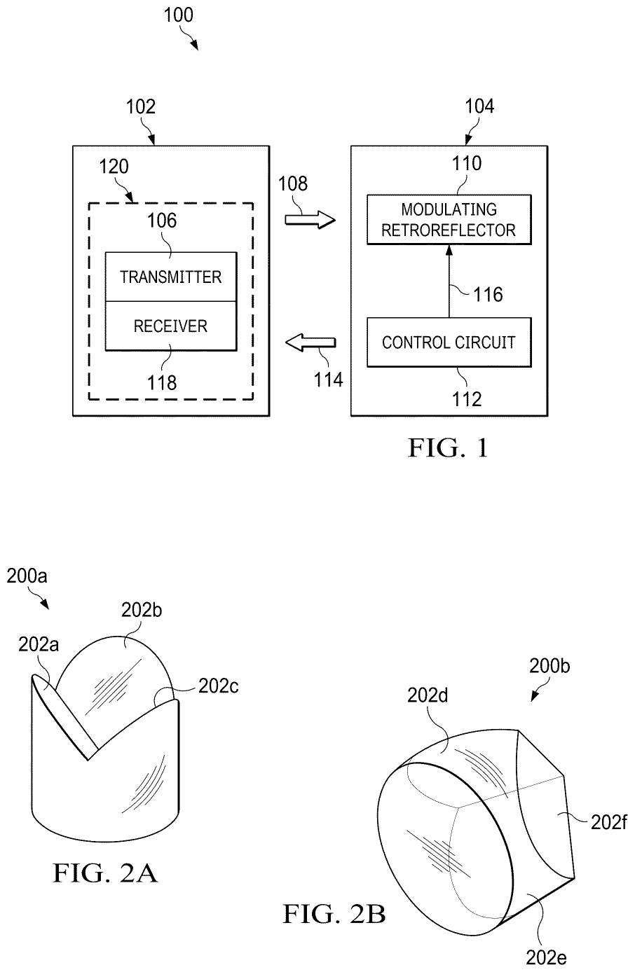

FIGS. 1 through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As described above, free-space optical systems generally include optical nodes that communicate or that otherwise transmit/receive light through free space rather than through fiber optic cables or other physical cables. In some free-space optical systems or other systems, a first optical node can be used to transmit optical signals towards a second optical node, where the second optical node includes a retroreflector. The retroreflector in the second optical node reflects the optical signals back towards the first optical node, which can receive and process the reflected optical signals. In some cases, the retroreflector in the second optical node may be used to impart phase, intensity, or other modulations to the optical signals being reflected. This allows the second optical node to encode data for transmission using the reflected optical signals. The first optical node can receive the reflected optical signals and recover the encoded data based on the phase, intensity, or other modulations contained in the reflected optical signals.

While modulating retroreflectors can represent low-cost, low-power, low-complexity solutions to enable functions such as free-space optical communications, there are significant limitations on the data rates of those optical communications. For example, conventional modulating retroreflectors provide single channel communication. Also, these retroreflectors have inherent speed limitations on communication based on the fundamental properties of their materials. In addition, conventional modulating retroreflectors using intensity modulation typically include a multiple quantum well (MQW) structure that changes the amount of light absorption based on an applied voltage. This type of modulating retroreflector is very lossy, sensitive to temperature, and has a narrow wavelength range of operation.

This disclosure provides various modulating retroreflectors supporting multi-channel communication. As described in more detail below, each of the modulating retroreflectors can include a plurality of reflective surfaces. Each of the reflective surfaces can include an optical coating and a modulating layer. Each of the optical coatings can be configured to transmit a specified wavelength of light different from one or more remaining optical coatings and to reflect specific wavelengths of light transmitted by the one or more remaining optical coatings. The reflective surfaces can be configured to receive an optical signal and to provide a reflected optical signal. For each of the reflective surfaces, the modulating layer can be configured to modulate the specified wavelength of light in the optical signal transmitted by the optical coating and encode data onto the optical signal at the specified wavelength such that the reflected optical signal represents a multi-channel modulated version of the optical signal.

In this way, the described techniques can increase the data rate that is achievable using a modulating retroreflector. In some embodiments, a single corner-cube retroreflector may provide multi-channel operation for up to three channels. Phase, intensity, or other modulation may be permitted from a corner-cube retroreflector over very broad operating wavelengths with low insertion loss. In addition, a rotationally-invariant optical design may be implemented without the need for active polarization control. In embodiments using phase modulation, increased detection sensitivity is inherent in the modulation format of binary phase-shift keying, as opposed to on-off keying, and multi-level phase modulation can be used for increased spectral efficiency. In embodiments using intensity modulation, simple direct detection of a reflected signal can be provided with wavelength-division multiplexing due to the multi-channel capability.

FIG. 1 illustrates an example of an optical system 100 including a modulating retroreflector supporting multi-channel communication according to this disclosure. The embodiment of the optical system 100 shown in FIG. 1 is for illustration only. Other embodiments of the optical system 100 may be used without departing from the scope of this disclosure.

According to embodiments of this disclosure, the optical system 100 includes two nodes 102 and 104. Each node 102 and 104 represents a ground-, air-, water-, or space-based system that can communicate or otherwise interact optically. In this example, the node 102 includes an optical transmitter 106, which generally operates to produce optical signals 108 used for communication or other purposes. For example, the optical transmitter 106 may represent a laser or other optical source that can generate the optical signals 108 for transmission towards the node 104.

The node 104 includes a modulating retroreflector 110 and a control circuit 112. The modulating retroreflector 110 receives the optical signals 108 from the node 102 and reflects the optical signals 108 back towards the node 102 as reflected optical signals 114. Based on a control signal 116 provided by the control circuit 112, the modulating retroreflector 110 is also configured to provide phase, intensity, or other modulations to the optical signals 108 in order to encode data onto the reflected optical signals 114. For example, the data encoded onto the reflected optical signals 114 may include identification information identifying the node 104 and/or data collected or otherwise obtained by the node 104. Note, however, that the control circuit 112 may encode any other or additional data onto the reflected optical signals 114.

As described in more detail below, the modulating retroreflector 110 includes multiple reflective surfaces, each of which includes multiple layers of materials. These materials include an optical coating for each reflective surface that can be different from the optical coatings of the remaining reflective surface(s). Each optical coating can be configured to transmit a specified wavelength of light to an underlying modulating layer and to reflect wavelengths of light other than the specified wavelength. Thus, each reflective surface can be configured to modulate the optical signal for the specified wavelength before reflecting the optical signal and to reflect the optical signal for other wavelengths without modulation. This allows each reflective surface to encode data for a different channel of communication, thereby increasing the data rate provided by the modulating retroreflector 110 by a factor corresponding to the number of reflective surfaces included in the modulating retroreflector 110.

The node 102 further includes an optical receiver 118 that receives the reflected optical signals 114 and decodes the modulations contained in the reflected optical signals 114 in order to recover the data from the reflected optical signals 114. Any suitable type(s) of modulation/demodulation scheme or schemes may be used here to encode and decode optical signals. In some cases, the optical receiver 118 may represent an etalon-based receiver, which can allow for end-to-end low size, weight, power, and cost (SWAP-C) free-space communications. Note that while the optical transmitter 106 and the optical receiver 118 are shown here as separate components, they can be integrated into a single optical transceiver 120. This may allow, for example, the same structure to be used for both transmission and reception purposes.

The nodes 102 and 104 here may find use in a large number of applications. For example, the nodes 102 and 104 may be used to support optical communications in various terrestrial and space-based applications, including applications that involve overt and/or covert data transfers. As particular examples, the nodes 102 and 104 may be used to support backhaul optical communications in 5G networks or other telecommunications networks or to support ship-to-shore or other ship-based communications. As other particular examples, the nodes 102 and 104 may be used to support optical communications for data exfiltration from disadvantaged platforms like micro-satellites and unmanned aerial vehicles (UAVs). As yet another particular example, the nodes 102 and 104 may be used to support point-to-point optical communications for various purposes. Note, however, that this disclosure is not limited to any particular application of the nodes 102 and 104 or the described modulating retroreflectors.

Although FIG. 1 illustrates one example of an optical system 100 including a modulating retroreflector 110 supporting multi-channel communication, various changes may be made to FIG. 1. For example, while only two nodes 102 and 104 are shown here, the optical system 100 may include any suitable number of nodes that engage in any suitable optical communications or other optical interactions with each other. Also, the optical system 100 is shown in simplified form here and may include any number of additional components in any suitable configuration as needed or desired. In addition, the view shown in FIG. 1 is not to scale.

FIGS. 2A and 2B illustrate examples of modulating retroreflectors 200a-200b supporting multi-channel communication according to this disclosure. The modulating retroreflectors 200a-200b may, for example, represent a possible implementation of the modulating retroreflector 110 in the node 104 of FIG. 1. However, the modulating retroreflectors 200a-200b may be used in any other suitable device(s) and in any other suitable system(s).

As shown in FIG. 2A, the modulating retroreflector 200a represents a hollow corner-cube retroreflector having three reflective surfaces 202a, 202b, and 202c. The reflective surfaces 202a-202c are arranged to reflect light back in the same, or a similar, direction from which the light is received. As shown in FIG. 2B, the modulating retroreflector 200b represents a solid corner-cube retroreflector having three reflective surfaces 202d-202f. Again, the reflective surfaces 202d-202f are arranged to reflect light back in the same, or a similar, direction from which the light is received. Thus, each modulating retroreflector 200a, 200b (if used as the modulating retroreflector 110 in the node 104 of FIG. 1) would reflect the optical signals 108 received from the node 102 back towards the node 102 as reflected optical signals 114.

In FIGS. 2A and 2B, each of the reflective surfaces 202a-202c, 202d-202fof the modulating retroreflectors 200a-200b may be implemented as a controllable modulating component. For example, each of the reflective surfaces 202a-202c, 202d-202f may be designed to be controlled so as to impart phase, intensity, or other modulations to optical signals being reflected by the reflective surfaces 202a-202c, 202d-202f.

As described in more detail below, each reflective surface 202a-202c, 202d-202f may include an optical coating that is different from the optical coatings of the remaining reflective surface(s) 202a-202c, 202d-202f. Each optical coating can be configured to transmit a specified wavelength of light to an underlying modulating layer and to reflect wavelengths of light other than the specified wavelength. Thus, each reflective surface 202a-202c, 202d-202f can be configured to modulate the optical signal for the specified wavelength before reflecting the optical signal and to reflect the optical signal for other wavelengths without modulation. This allows each reflective surface 202a-202c, 202d-202f to encode data for a different channel of communication, thereby increasing the data rate provided by the modulating retroreflector 200a-200b by a factor of three as compared to a conventional modulating retroreflector.

The modulating retroreflector 200a, 200b can communicate with any suitable number of interrogators (such as the node 102 of FIG. 1) using one, two, or all three wavelengths for communicating with each interrogator. For example, the modulating retroreflector 200a, 200b can communicate with a single interrogator, which can send all three wavelengths of light. The modulating retroreflector 200a, 200b can also communicate with two or three interrogators, each communicating with its own wavelength of light. In addition, the modulating retroreflector 200a, 200b can communicate with one interrogator using one wavelength and can communicate at the same time with another interrogator using the same wavelength, the other two wavelengths, or all three wavelengths. The modulating retroreflector 200a, 200b can communicate with any suitable number of interrogators and can communicate with any combination of one or more of the wavelengths for each one of the interrogators.

Although FIGS. 2A and 2B illustrate examples of modulating retroreflectors 200a-200b supporting multi-channel communication, various changes may be made to FIGS. 2A and 2B. For example, the modulating retroreflectors 200a-200b can include electrical connections to the control circuit 112. Also, as described in more detail below, each of the reflective surfaces 202a-202c, 202d-202f can include layers in addition to the optical coatings and modulating layers. In addition, the views shown in FIGS. 2A and 2B are not to scale.

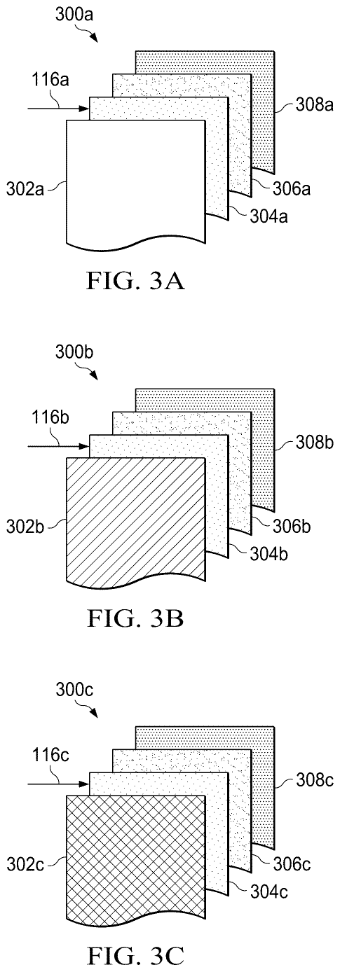

FIGS. 3A through 3C illustrate examples of reflective surfaces 300a-300cof a modulating retroreflector supporting multi-channel communication according to this disclosure. The embodiments of the reflective surfaces 300a-300c shown in FIGS. 3A through 3C are for illustration only. Other embodiments of the reflective surfaces 300 a-300cmay be used without departing from the scope of this disclosure. Each of the reflective surfaces 300a-300c may, for example, represent a possible implementation of one of the reflective surfaces 202a-202c, 202d-202f of one of the modulating retroreflectors 200a, 200b of FIG. 2. However, the reflective surfaces 300a-300c may be used in any other suitable modulating retroreflector.

According to embodiments of this disclosure, each of the reflective surfaces 300a-300c may include multiple layers, including an optical coating 302a-302c, a modulating layer 304a-304c, a base reflector 306a-306c, and a substrate layer 308a-308c. Each of the optical coatings 302a-302c may include a material that is different from the other optical coating(s) 302a-302c such that each corresponding reflective surface 300a-300c can be configured to modulate a different channel for communication through a different wavelength of light. Thus, each of the optical coatings 302a-302c may include a material that is anti-reflective for a specified wavelength of light and high-reflective for other wavelengths of light. In some embodiments, the optical coatings 302a-302c may include different dielectric coatings of silicon dioxide/titanium dioxide that each transmit a different wavelength of light.

In some embodiments, each of the optical coatings 302a-302c may include a material that is high-reflective, in particular, for the specified wavelengths of light for the remaining optical coatings 302a-302c. For example, a first optical coating 302a for a first reflective surface 300a may include a material that is anti-reflective for a first wavelength of light, a second optical coating 302b for a second reflective surface 300b may include a material that is anti-reflective for a second wavelength of light, and a third optical coating 302c for a third reflective surface 300c may include a material that is anti-reflective for a third wavelength of light. The material of the first optical coating 302a may also be high-reflective for the second and third wavelengths of light, the material of the second optical coating 302b may be high-reflective for the first and third wavelengths of light, and the material of the third optical coating 302c may be high-reflective for the first and second wavelengths of light. As a particular example, the first wavelength may be about 800 nm, the second wavelength may be about 850 nm, and the third wavelength may be about 900 nm. However, each of the wavelengths may be any suitable length based on the design or requirements of the optical system 100.

The first optical coating 302a may be configured to transmit the first wavelength of light in the optical signal 108 through to a first modulating layer 304a. Similarly, the second optical coating 302b may be configured to transmit the second wavelength of light in the optical signal 108 through to a second modulating layer 304b. In addition, the third optical coating 302c may be configured to transmit the third wavelength of light in the optical signal 108 through to a third modulating layer 304c.

Each of the modulating layers 304a-304c may include a transparent material whose optical properties can be changed by applying a voltage to the material through the control signal 116, thereby allowing for encoding of data onto the optical signal 108. For example, the control signal 116 can change the index of refraction for the material of the modulating layers 304a-304c. In some embodiments, the modulating layers 304a-304c may include a ferroelectric ceramic, such as lead lanthanum zirconate titanate (PLZT), lithium niobate, or other suitable ferroelectric, or a dielectric ceramic, such as barium titanium (BaTi) or other suitable dielectric ceramic. In particular embodiments, the ferroelectric or dielectric ceramic can be fabricated as one or more thin films in order to form the modulating layers 304a-304c. In embodiments using PLZT, the modulating layers 304a-304c can be very responsive to applied voltages, very thin, and very low loss.

Each of the modulating layers 304a-304c can be positioned between the respective optical coating 302a-302c and the respective base reflector 306a-306c for the respective reflective surface 300a-300c. Each of the modulating layers 304a-304c may be electrically coupled to the control circuit 112 and thereby configured to receive a control signal 116 from the control circuit 112. The control signal 116 generated by the control circuit 112 may include multiple control signals 116a-116c such that a different control signal 116a-116ccan be provided to each modulating layer 304a-304c. In some embodiments, the control signal 116a-116c can include specified voltages, with the voltage provided through each control signal 116a-116c controlling the modulating layer 304a-304c to encode data onto the optical signal 108 through modulation of the optical signal 108.

Based on the control signal 116a-116c received at a particular modulating layer 304a-304c, the specified wavelength of light received at that particular modulating layer 304a-304c can be modulated to encode data onto that specified wavelength of light in the optical signal 108. In this way, three channels of communication can be provided by the modulating retroreflector 200a-200b based on the three different reflective surfaces 300a-300cproviding modulation to encode three different wavelengths of light in the optical signal 108.

In some embodiments, the modulating layers 304a-304c may be configured to provide phase modulation to encode the data. In these embodiments, a voltage applied through the control signal 116a-116c can change an index of refraction for the corresponding modulating layer 304a-304c, which changes the phase of the light to encode data onto the optical signal 108. The material of the modulating layers 304a-304c in this case can have substantially no polarization and no strong angular dependence so that the phase of light can be predictably changed regardless of how the light is oriented.

In some embodiments, the modulating layers 304a-304c may be configured to provide intensity modulation to encode the data. In these embodiments, each of the modulating layers 304a-304c can include an oriented phase-shifting material that has sensitivity to the orientation of the incoming light. Thus, the material can be selected such that, based on the control signal 116a-116c, the light can either be not rotated or be rotated such that the polarization of the reflected optical signal 114 is rotated with respect to the polarization of the incoming optical signal 108 by 90 degrees.

Each base reflector 306a-306c may include a material that is configured to reflect substantially all wavelengths of light included in the optical signal 108. Each base reflector 306a-306c may include gold or other reflective metal, a dielectric coating, or any other suitable reflective material. In some embodiments, each of the base reflectors 306a-306c can be positioned between the respective modulating layer 304a-304c and the respective substrate layer 308a-308c for the respective reflective surface 300a-300c. Each substrate layer 308a-308c may include fused silica (glass), silicon, or other suitable optically-stable solid. In contrast to the optical coatings 302a-302c, in some embodiments, the modulating layers 304a-304c may each include the same material, the base reflectors 306a-306c may each include the same material, and the substrate layers 308a-308c may each include the same material.

In some embodiments in which the reflective surfaces 300a-300c are provided as part of the hollow corner-cube modulating retroreflector 200a, the substrate layer 308a-308c may be provided as a first layer of the reflective surface 300a-300c on an interior side of the hollow corner-cube modulating retroreflector 200a. The base reflector 306a-306c may be applied over the substrate layer 308a-308c, the modulating layer 304a-304c may be applied over the base reflector 306a-306c, and each of the different optical coatings 302a-302c may be applied over a corresponding modulating layer 304a-304c.

In some embodiments in which the reflective surfaces 300a-300c are provided as part of the solid corner-cube modulating retroreflector 200b, each of the different optical coatings 302a-302c may be applied over a corresponding exterior, back side of the solid corner-cube modulating retroreflector 200b as a first layer of the reflective surface 300a-300c. The modulating layer 304a-304c may be applied over the optical coating 302a-302c, and the base reflector 306a-306c may be applied over the modulating layer 304a-304c. In these embodiments, the substrate layer 308a-308c may be omitted.

In operation, in some embodiments, when an incoming optical signal 108 is received at the modulating retroreflector 200a, 200b, the light in the optical signal 108 incident on the reflective surfaces 300a-300c is first received at the optical coatings 302a-302c. The first wavelength of light in the optical signal 108 is transmitted through the first optical coating 302a to the first modulating layer 304a, where a first control signal 116a controls the first modulating layer 304a to encode data for a first channel of communication onto the first wavelength of light. The optical signal 108 including the encoded data for the first channel is reflected off the first base reflector 306a. Meanwhile, the second and third wavelengths of light in the optical signal 108 are reflected off the first optical coating 302a.

Similarly, the second wavelength of light in the optical signal 108 is transmitted through the second optical coating 302b to the second modulating layer 304b, where a second control signal 116b controls the second modulating layer 304b to encode data for a second channel of communication onto the second wavelength of light. The optical signal 108 including the encoded data for the second channel is reflected off the second base reflector 306b. Meanwhile, the first and third wavelengths of light in the optical signal 108 are reflected off the second optical coating 302b.

In addition, the third wavelength of light in the optical signal 108 is transmitted through the third optical coating 302c to the third modulating layer 304c, where a third control signal 116c controls the third modulating layer 304a to encode data for a third channel of communication onto the third wavelength of light. The optical signal 108 including the encoded data for the third channel is reflected off the third base reflector 306c. Meanwhile, the first and second wavelengths of light in the optical signal 108 are reflected off the third optical coating 302c.

Note that all wavelengths of the optical signal 108 are reflected off each reflective surface 300a-300c, either by the optical coating 302a-302c (for wavelengths not to be encoded by the corresponding modulating layer 304a-304c) or by the base reflector 306a-306c (for wavelengths that are encoded by the corresponding modulating layer 304a-304c). After reflecting off all three reflective surfaces 300a-300c, the modulated optical signal 108 is sent back as the reflected optical signal 114 in the same or similar direction from which the optical signal 108 was received. The optical receiver 118 can receive the reflected optical signal 114 and decode the modulations contained in the reflected optical signal 114 in order to recover the data encoded onto the reflected optical signal 114. In this way, the modulating retroreflectors 200a-200b can achieve data rates three times higher than prior approaches by providing data encoding on multiple (such as three) separate channels of communication in the reflected optical signal 114.

Although FIGS. 3A through 3C illustrate examples of reflective surfaces 300a-300c of a modulating retroreflector supporting multi-channel communication, various changes may be made to FIGS. 3A through 3C. For example, the reflective surfaces 300a-300c may include additional layers not shown in FIGS. 3A through 3C. In addition, note that the views shown in FIGS. 3A through 3C are not to scale.

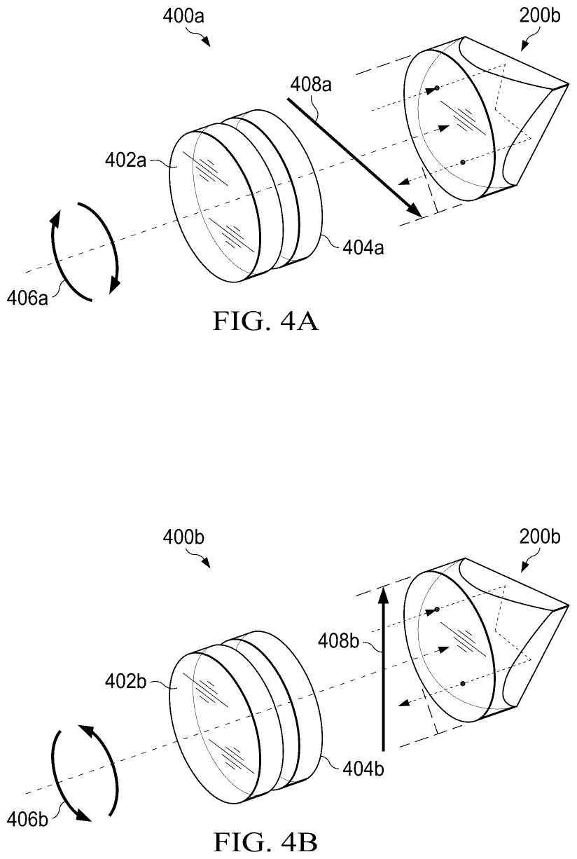

FIGS. 4A and 4B illustrate examples of a structure 400a, 400b for use in providing intensity modulation encoding with the modulating retroreflector 200b of FIG. 2B according to this disclosure. The embodiments of the structures 400a-400b shown in FIGS. 4A and 4B are for illustration only. Other embodiments of the structure 400a, 400b may be used without departing from the scope of this disclosure.

As shown in FIGS. 4A and 4B, each of the structures 400a-400b may include the solid corner-cube modulating retroreflector 200b, a quarter-wave plate 402a-402b, and a polarizer 404a-404b. Each quarter-wave plate 402a-402b may be configured to convert incoming, circularly polarized light into outgoing, linearly polarized light and to convert incoming, linearly polarized light into outgoing, circularly polarized light. Each polarizer 404a-404b may be configured to transmit linearly polarized light of a particular orientation and to block transmission of linearly polarized light without the particular orientation. Based on the control signal 116, the structure 400a, 400b can either block the light of the optical signal 108 or can reflect the light back as the reflected optical signal 114 with very low loss.

In the example shown in FIG. 4A, an incoming, right-hand circularly polarized light beam 406a may be incident on the quarter-wave plate 402a. The quarter-wave plate 402a may convert the right-hand circularly polarized light beam 406a into linearly polarized light with a horizontal orientation. The polarizer 404a may include a right circular polarizer such that the polarizer 404a may propagate the linearly polarized light with a horizontal orientation output from the quarter-wave plate 402a, thereby providing a low-loss horizontal input 408a to the modulating retroreflector 200b.

When no voltage is applied to a modulating layer 304 of the modulating retroreflector 200b by the control signal 116 from the control circuit 112, the modulating retroreflector 200b may reflect the received horizontal input 408a as a vertical output. When the vertical output is incident on the polarizer 404a, the vertical output is substantially blocked because of its orientation. Thus, the reflected optical signal 114 for this scenario would essentially be a zero (no light would be provided back to the optical receiver 118).

However, when the control signal 116 applies a specified voltage to the modulating layer 304 of the modulating retroreflector 200b, the modulating retroreflector 200b may reflect the received horizontal input 408a as a horizontal output. When the horizontal output is incident on the polarizer 404a, the polarizer 404a propagates the horizontal output back through the quarter-wave plate 402a because of its orientation. Thus, the reflected optical signal 114 for this scenario would essentially be a one (light would be provided back to the optical receiver 118). In this way, by applying or not applying the specified voltage to the modulating layer 304, data can be encoded onto the optical signal 114 through intensity modulation.

In the example shown in FIG. 4B, an incoming, left-hand circularly polarized light beam 406b may be incident on the quarter-wave plate 402b. The quarter-wave plate 402b may convert the left-hand circularly polarized light beam 406b into linearly polarized light with a vertical orientation. The polarizer 404b may include a left circular polarizer such that the polarizer 404b may propagate the linearly polarized light with a vertical orientation output from the quarter-wave plate 402b, thereby providing a low-loss vertical input 408b to the modulating retroreflector 200b.

When no voltage is applied to a modulating layer 304 of the modulating retroreflector 200b by the control signal 116 from the control circuit 112, the modulating retroreflector 200b may reflect the received vertical input 408b as a horizontal output. When the horizontal output is incident on the polarizer 404b, the horizontal output is substantially blocked because of its orientation. Thus, the reflected optical signal 114 for this scenario would essentially be a zero (no light would be provided back to the optical receiver 118).

However, when the control signal 116 applies a specified voltage to the modulating layer 304 of the modulating retroreflector 200b, the modulating retroreflector 200b may reflect the received vertical input 408b as a vertical output. When the vertical output is incident on the polarizer 404b, the polarizer 404b propagates the vertical output back through the quarter-wave plate 402b because of its orientation. Thus, the reflected optical signal 114 for this scenario would essentially be a one (light would be provided back to the optical receiver 118). In this way, by applying or not applying the specified voltage to the modulating layer 304, data can be encoded onto the reflected optical signal 114 through intensity modulation.

By implementing the structure 400a, 400b to provide intensity modulation encoding in an optical system, such as the optical system 100, the entire structure 400a, 400b can be rotated with respect to the incoming optical signal 108 without affecting the encoding process. The circularly polarized light can be converted to a horizontal input 408a (for the structure 400a) or vertical input 408b (for the structure 400b) independent of the orientation of the structure 400a-400b. In this way, the structure 400a, 400b is configured to provide a rotationally-invariant optical design that may be implemented without the need for active polarization control.

Although FIGS. 4A and 4B illustrate examples of a structure 400a, 400b for use in providing intensity modulation encoding with the modulating retroreflector 200b, various changes may be made to FIGS. 4A and 4B. For example, the structure 400a, 400b may include additional components not shown in FIG. 4A or 4B. In addition, note that the views shown in FIGS. 4A and 4B are not to scale.

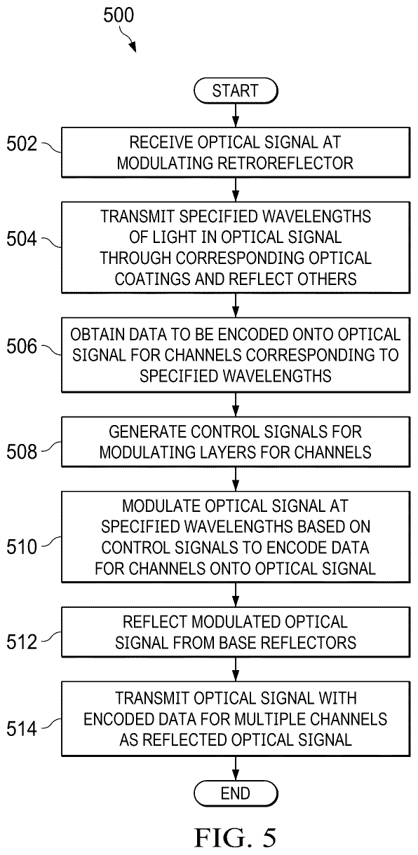

FIG. 5 illustrates an example of a method 500 for providing multi-channel communication with a modulating retroreflector according to this disclosure. For ease of explanation, the method 500 shown in FIG. 5 is described as being performed using one of the modulating retroreflectors 110 or 200a-200b, where each of the reflective surfaces 202a-202c or 202d-f includes a variation of one of the reflective surfaces 300a-300c, which may be used in the optical system 100 of FIG. 1. However, the method 500 shown in FIG. 5 may be performed using any other suitable modulating retroreflector designed in accordance with this disclosure and in any other suitable system.

As shown in FIG. 5, an optical signal is received at a modulating retroreflector at step 502. This may include, for example, the modulating retroreflector 110, 200a-200b of the node 104 receiving an optical signal 108 transmitted by the optical transmitter 106 of the node 102. Specified wavelengths of light in the optical signal are transmitted through corresponding optical coatings while other wavelengths are reflected at step 504. This may include, for example, a first wavelength being transmitted through a first optical coating 302a, a second wavelength being transmitted through a second optical coating 302b, and a third wavelength being transmitted through a third optical coating 302c. This may also include the second and third wavelengths being reflected off the first optical coating 302a, the first and third wavelengths being reflected off the second optical coating 302b, and the first and second wavelengths being reflected off the third optical coating 302c.

Data to be encoded onto the optical signal for channels corresponding to the specified wavelengths is obtained at step 506. This may include, for example, the control circuit 112 or other component of the node 104 retrieving data from a memory, generating data, and/or otherwise obtaining data to be encoded onto the optical signal 108 for each of the channels of communication. Control signals for modulating layers of the modulating retroreflector are generated for the multiple channels of communication at step 508. This may include, for example, the control circuit 112 generating a separate control signal 116a-116c for each one of the modulating layers 304a-304c. In some embodiments, the control signals 116a-116c may contain pulses, where the number, size, and/or other characteristic(s) of the pulses can be controlled based on the data to be encoded onto the wavelengths corresponding to the communication channels of the optical signal 108.

The optical signal is modulated based on the control signals in order to encode the data for the channels onto the optical signal at step 510. This may include, for example, one or more of the modulating layers 304a-304c of the modulating retroreflector 110, 200a-200bimparting phase, intensity, or other modulations onto the optical signal 108 based on the control signals 116a-116c from the control circuit 112. In this way, each of the modulating layers 304a-304c can separately encode data for a different channel of communication, thus increasing the amount of data that can be included in the optical signal 108 based on the number of different optical coatings 302a-302c. The modulated optical signal is reflected from the base reflectors at step 512. This may include, for example, the modulated optical signal 108 for each channel being reflected from a corresponding base reflector 306a-306c.

The optical signal encoded with data for multiple channels is transmitted from the modulating retroreflector as a reflected optical signal at step 514. This may include, for example, the modulating retroreflector 110, 200a-200b providing the modulated optical signal 108 as the reflected optical signal 114, which can be sent back in the same, or a similar direction, from which the optical signal 108 was received. The node 102 can therefore receive the reflected optical signal 114 using the optical receiver 118 and decode the modulations contained in the reflected optical signal 114 in order to recover the data encoded onto the reflected optical signal 114 by the modulating layers 304a-304c based on the control signals 116a-116c provided by the control circuit 112. In this way, multiple channels of communication may be provided by a modulating retroreflector 110, 200a-200b, thereby increasing the maximum possible data rate in accordance with the number of reflective surfaces 202a-202c, 202d-202f, 300a-300c.

Although FIG. 5 illustrates one example of a method 500 for providing multi-channel communication with a modulating retroreflector, various changes may be made to FIG. 5. For example, while shown as a series of steps, various steps in FIG. 5 may overlap, occur in parallel, occur in a different order, or occur any number of times (including zero times).

It may be advantageous to set forth definitions of certain words and phrases used throughout this patent document. The term “about” (when used with a numerical value) indicates that the numerical value may vary by up to ±10%. The terms “include” and “include,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 120(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 120(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a modulating retroreflector comprising a plurality of reflective surfaces, each of the reflective surfaces comprising an optical coating and a modulating layer;
wherein each of the optical coatings is configured to transmit a specified wavelength of light different from one or more remaining optical coatings and to reflect specific wavelengths of light transmitted by the one or more remaining optical coatings;
wherein the reflective surfaces are configured to receive an optical signal and to provide a reflected optical signal; and
wherein, for each of the reflective surfaces, the modulating layer is configured to modulate the specified wavelength of light in the optical signal transmitted by the optical coating and encode data onto the optical signal at the specified wavelength such that the reflected optical signal represents a multi-channel modulated version of the optical signal.

2. The apparatus of claim 1, wherein each of the optical coatings comprises a dielectric coating of silicon dioxide/titanium dioxide that is configured to transmit a different wavelength of light from the one or more remaining optical coatings.

3. The apparatus of claim 1, wherein:
each of the reflective surfaces further comprises a base reflector; and
for each of the reflective surfaces, the modulating layer is positioned between the optical coating and the base reflector.

4. The apparatus of claim 1, wherein each of the modulating layers is configured to provide phase modulations to the optical signal to encode the data onto the optical signal.

5. The apparatus of claim 1, wherein each of the modulating layers is configured to provide intensity modulations to the optical signal to encode the data onto the optical signal.

6. The apparatus of claim 5, wherein each of the modulating layers comprises an oriented phase-shifting material.

7. The apparatus of claim 1, wherein each of the modulating layers comprises at least one of a ferroelectric ceramic and a dielectric ceramic.

8. The apparatus of claim 1, wherein each of the modulating layers comprises at least one of lead lanthanum zirconate titanate (PLZT), lithium niobate, and barium titanium (BaTi).

9. The apparatus of claim 1, wherein the modulating retroreflector comprises a solid corner-cube modulating retroreflector, the apparatus further comprising:
a quarter-wave plate configured to receive circularly polarized light and to transmit linearly polarized light based on the circularly polarized light; and
a polarizer positioned between the quarter-wave plate and the modulating retroreflector, the polarizer configured to transmit the linearly polarized light with a specified orientation to the modulating retroreflector;
wherein the modulating retroreflector is configured to reflect the linearly polarized light received from the polarizer having an orientation rotated by 90 degrees with respect to the specified orientation when no voltage is applied to the modulating retroreflector and to reflect the linearly polarized light received from the polarizer having the specified orientation when a specified voltage is applied to the modulating retroreflector.

10. A system comprising:
a modulating retroreflector comprising:
a plurality of reflective surfaces, each of the reflective surfaces comprising an optical coating and a modulating layer;
wherein each of the optical coatings is configured to transmit a specified wavelength of light different from one or more remaining optical coatings and to reflect specific wavelengths of light transmitted by the one or more remaining optical coatings;
wherein the reflective surfaces are configured to receive an optical signal and to provide a reflected optical signal; and
wherein, for each of the reflective surfaces, the modulating layer is configured to modulate the specified wavelength of light in the optical signal transmitted by the optical coating and encode data onto the optical signal at the specified wavelength such that the reflected optical signal represents a multi-channel modulated version of the optical signal; and
a control circuit configured to generate a plurality of control signals and to provide one of the plurality of control signals to each of the modulating layers to control the encoding of the data onto the optical signal at each of the modulating layers.

11. The system of claim 10, wherein each of the optical coatings comprises a dielectric coating of silicon dioxide/titanium dioxide that is configured to transmit a different wavelength of light from the one or more remaining optical coatings.

12. The system of claim 10, wherein:
each of the reflective surfaces further comprises a base reflector; and
for each of the reflective surfaces, the modulating layer is positioned between the optical coating and the base reflector.

13. The system of claim 10, wherein each of the modulating layers is configured to provide phase modulations to the optical signal to encode the data onto the optical signal.

14. The system of claim 10, wherein each of the modulating layers is configured to provide intensity modulations to the optical signal to encode the data onto the optical signal.

15. The system of claim 14, wherein each of the modulating layers comprises an oriented phase-shifting material.

16. The system of claim 10, wherein each of the modulating layers comprises at least one of a ferroelectric ceramic and a dielectric ceramic.

17. The system of claim 10, wherein each of the modulating layers comprises at least one of lead lanthanum zirconate titanate (PLZT), lithium niobate, and barium titanium (BaTi).

18. The system of claim 10, wherein the modulating retroreflector comprises a solid corner-cube modulating retroreflector, the system further comprising:
a quarter-wave plate configured to receive circularly polarized light and to transmit linearly polarized light based on the circularly polarized light; and
a polarizer positioned between the quarter-wave plate and the modulating retroreflector, the polarizer configured to transmit the linearly polarized light with a specified orientation to the modulating retroreflector;
wherein the modulating retroreflector is configured to reflect the linearly polarized light received from the polarizer having an orientation rotated by 90 degrees with respect to the specified orientation when no voltage is applied to the modulating retroreflector and to reflect the linearly polarized light received from the polarizer having the specified orientation when a specified voltage is applied to the modulating retroreflector.

19. A method comprising:
receiving an optical signal at a modulating retroreflector, the modulating retroreflector comprising a plurality of reflective surfaces configured to receive the optical signal and to provide a reflected optical signal, each of the reflective surfaces comprising a modulating layer and a corresponding optical coating;
at each of the optical coatings, transmitting a specified wavelength of light different from one or more remaining optical coatings and reflecting specific wavelengths of light transmitted by the one or more remaining optical coatings; and
at each of the modulating layers, modulating the specified wavelength of light in the optical signal transmitted by the corresponding optical coating and encoding data onto the optical signal at the specified wavelength such that the reflected optical signal represents a multi-channel modulated version of the optical signal.

20. The method of claim 19, further comprising:
generating a plurality of control signals; and
providing one of the plurality of control signals to each of the modulating layers to control the encoding of the data onto the optical signal at the modulating layer.
